(19) United States
(12) Patent Application Publication
(10) Pub. No.: US 2005/0114691 A1
(43) Pub. Date: May 26, 2005

(54) Micro electronic device with plurality of encryption/decryption logic

(76) Inventor: Thomas J. Gilg, Shedd, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/719,724

(22) Filed: Nov. 21, 2003

(51) Int. Cl. H04L 9/00

(52) U.S. Cl. 713/200

(57) ABSTRACT

The digital picture capturing device or a digital picture display device includes a plurality of pixel elements which are encrypted or decrypted with a plurality of encryption or decryption keys.

### BACKGROUND

Conventional digital picture display systems commonly receive a digital data stream of picture information from an unsecured source, such as a computer connected to the Internet or other unsecure network, for generating a display from the digital data stream. To prevent unauthorized access, such digital picture displays commonly utilize encryption and decryption techniques to ensure that only authorized or desired individuals view the picture information that is transmitted to the display. For example, the data stream is encrypted before it is transmitted by the source, and the encrypted data stream is decrypted after it is received by the digital picture display system and before it is displayed. This encryption/decryption technique makes it more difficult for unauthorized individuals to tap into the transmitted data stream and recover and view the picture information.

Such encryption techniques commonly encrypt the entire digital picture information at the source and decrypt the entire transmitted data stream at the destination. After the data stream is decrypted at the destination, the decrypted display information is transmitted to pixels or other display means in the display device for viewing. While such a system provides protection from unauthorized access, drawbacks do exist. Specifically, such systems commonly use only one encryption and decryption key. As such, an unauthorized individual attempting to decrypt the encrypted information need only obtain the one decryption key. Additionally, both encryption and decryption is done at locations in the video capture and video display devices physically removed from the pixels, such as in a video card, thereby allowing a receiving display device to tap into the circuitry between the decryption and encryption software and the pixel elements to obtain the unencrypted information. The present embodiments were developed in light of these and other drawbacks.

### BRIEF DESCRIPTION OF THE DRAWINGS

The present invention will now be described, by way of example, with reference to the accompanying drawings, in which:

FIG. 1 is a schematic view of a pixel array according to an aspect of the present embodiments;

FIG. 2 is a schematic view of a pixel according to an aspect of the present embodiments; and

FIG. 3 is a schematic view of a pixel according to an aspect of the present embodiments.

### DETAILED DESCRIPTION

An encryption and decryption scheme according to an embodiment encrypts portions of a digital picture with different encryption keys. The digital picture is encrypted at a source device, which can be a digital video camera or other digital picture capturing device. Each portion of the digital picture is then transmitted to a destination device, such as a digital display, thereby requiring the destination device to decrypt each portion of the transmitted digital picture with different decryption keys in order to be able to see the complete transmitted digital picture. Such a system makes it difficult for an unauthorized individual to decrypt the transmitted digital picture, as the unauthorized individual must decrypt all transmitted portions before being able to view the entire transmitted digital picture. Additionally, such encryption and decryption can take place right at the pixel level in the source device and destination device, thereby preventing an unauthorized individual from tapping into a location between encryption circuitry and the pixel in an attempt to bypass the encryption process and illegally capture the digital picture. According to another embodiment, such a system also makes it possible for an individual to decrypt some portions of a digital picture, and not be able to decrypt other portions of the digital picture.

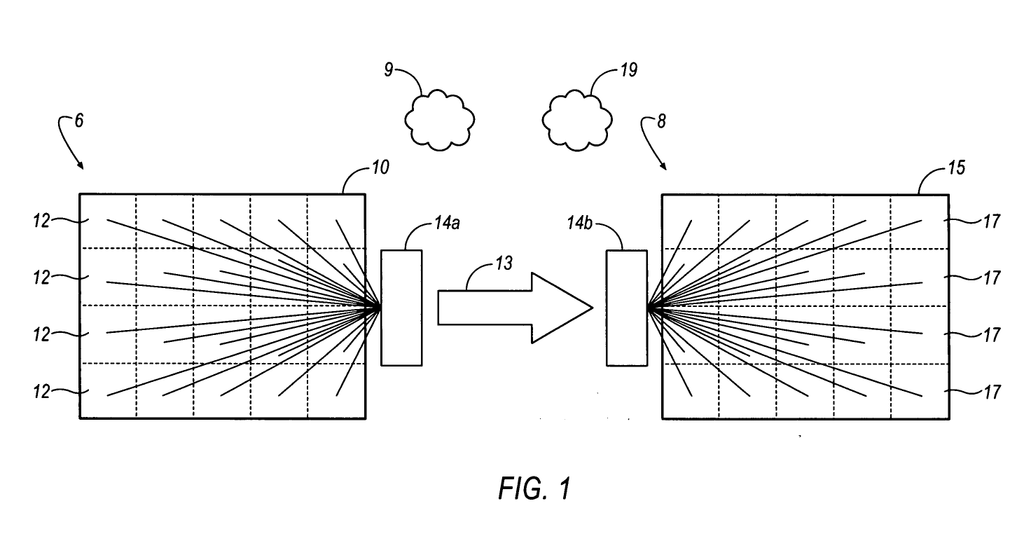

Referring now to FIG. 1, a source device 6 is shown being used in conjunction with a receiving device 8 according to the described embodiments. The source device 6, for example, may be a digital camera, CCD or other known means of capturing digital picture information. Alternatively, the source device 6 may be a storage device for storing digital picture information such as the hard drive of a computer. The receiving device 8 is a display device such as a video screen, flat-panel display, TFT (thin film transistor) or other known means of displaying digital picture information. Similar to source device 6, receiving device 8 can alternatively be a device for storing digital picture information. The source device 6 and receiving device 8 and corresponding components may be constructed in any known manner and include components such as those disclosed in U.S. Pat. Nos. 6,545,655 B1 and 6,563,480 B1, the disclosures of which are hereby incorporated by reference.

The source device 6 communicates with the receiving device 8 across a network 13, which may be an unsecured network. For example, network 13 may be a LAN, internet, intranet, wireless link or any other known means for communicating digital information which is shared among numerous people, some of which may not be authorized to view information transmitted from the source device 6 to the receiving device 8. The network may also include any digital connectors such as DVI (digital video interface) and IEEE-1394 connectors.

In FIG. 1, the source device 6 is shown having a source pixel array 10 which includes a matrix of source pixels 12 for capturing digital picture information. Such source pixels 12, for example, can be the receiving elements of a CCD device or other suitable components of a digital picture capturing device. One skilled in the art will recognize numerous other means for capturing digital video information besides that disclosed herein which may be represented by the source pixels 12.

The source device 6 also includes pixel logic 14a. The pixel logic 14a may be the software, logic or algorithm that accesses the pixel information from source pixels 12 if the pixels are stored in files, and the hardware (physical circuit) logic that accesses the pixel information from source pixels 12 if the pixels are retrieved from hardware. As will be readily understood by one skilled in the art, the network 13 depends on the pixel logic 14a to access digital picture information from the source device 6.

The source device 6 also includes encryption logic 9 that encrypts the digital video data captured by the source pixels 12 of the source device 6. The encryption logic 9 can utilize any known encryption technique such as public/private encryption keys or same key encryption techniques as will be readily understood by one skilled in the art. However, the source device also utilizes a multiple encryption key technique as will be discussed in greater detail below. The encryption logic 9 is shown in FIG. 1 as a cloud to represent that the encryption logic 9 may be positioned at various places within the source device 6, depending on the particular embodiment. For example, the encryption logic 9 can exist at the pixel level within each of the source pixels 12 or can be a higher level algorithm positioned after the pixel logic 14a collates all the information from each of the source pixels 12. The application of encryption logic 9 will be discussed in greater detail below.

The receiving device 8 is a display device for displaying the digital picture information received from source device 6. The display may be an active matrix, passive matrix, thin film transistor TFT or any other known picture display device. Receiving device 8 includes a receiving pixel array 15, which has a plurality of receiving pixels 17 that illuminate to form a picture in response to the digital video data stream representing the digital picture information received from source device 6. Such picture information may include, but is not limited to, digital still or video images and can be formatted as TIF, JPEG, MPEG 2 or h.261, or any other known digital picture format.

Receiving pixel logic 14b receives the digital video data stream from source device 6 and formats and addressably sends the information to respective receiving pixels 17 such that the receiving pixel array 15 can display the digital picture information. Similar to source device 6, receiving device 8 includes a decryption logic 19 that decrypts the encrypted data stream received from source device 6. Similar to source device 6, the decryption logic 19 may be located at various places within the receiving device 8 as will be discussed in greater detail hereinafter.

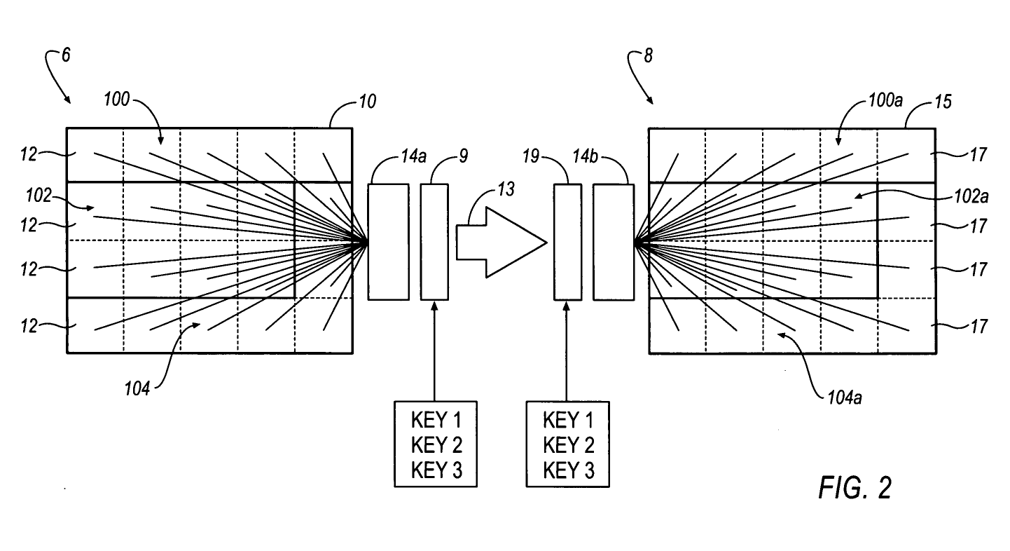

Referring now to FIG. 2, an encryption technique according to an embodiment is shown and described. In FIG. 2, pixels 12 of source device 6 are divided into three separate regions 100, 102 and 104. The pixel logic 14a identifies each of the separate regions 100, 102 and 104 and dispatches the digital picture information captured from these regions to the encryption logic 9. Such techniques for describing specific pixel regions will be readily known and understood by one skilled in the art. For example, a bitmap may be applied to the source pixels 12 to assign numbers to each region. For example, number 1 may be applied to region 100, number 2 may be applied to region 102, and number 3 may be applied to region 103. The pixel logic 14a then identifies each separate region by number 1, 2 or 3 and dispatches the captured digital picture information to the encryption logic 9. Encryption logic 9 then encrypts each region 100, 102 and 104 with a different encryption key for each region. The encrypted regions 100, 102 and 104 are then dispatched across network 13 as a data stream of digital picture information to receiving device 8.

Decryption logic 19 receives this data stream and decrypts it by applying each of three required decryption keys for regions 100, 102 and 104. The decrypted digital picture information is then sent to the receiving pixels 17 for each respective region 100a, 102a and 104a of receiving device 8 to display. As will be understood, three separate and different decryption keys are required to be able to display the entire digital picture. This increases the difficulty in improperly or illegally decrypting the entire digital picture as more than one decryption key is needed to access the entire digital picture information. The regions 100, 102 and 104 may be of any shape and include any number of pixels. A given display area may be divided up into any number of pixel regions.

In a modified embodiment of the above-described configuration, the receiving device 8 may be given only some of the required decryption keys to thereby allow that particular receiving device 8 to only display certain regions. For example, the receiving device 8 may be only given the decryption keys for regions 100 and 102. Thereby, the receiving device 8 is only able to display regions 100 and 102, and is unable to display region 104. For example, if picture information was being transmitted to a company, in which the transmitter of the information desired the employees to see only a portion of the information and the board of directors to see the entire picture information, then the receiving device 8 accessed by the board of directors would be provided with all of the decryption keys, while the receiving device 8 for the remainder of the employees would be provided with only a portion of the decryption keys for the pixels that they are allowed to view. As a result, the board of directors would be able to view all of the picture information, while the employees would only be able to view a portion of the picture information.

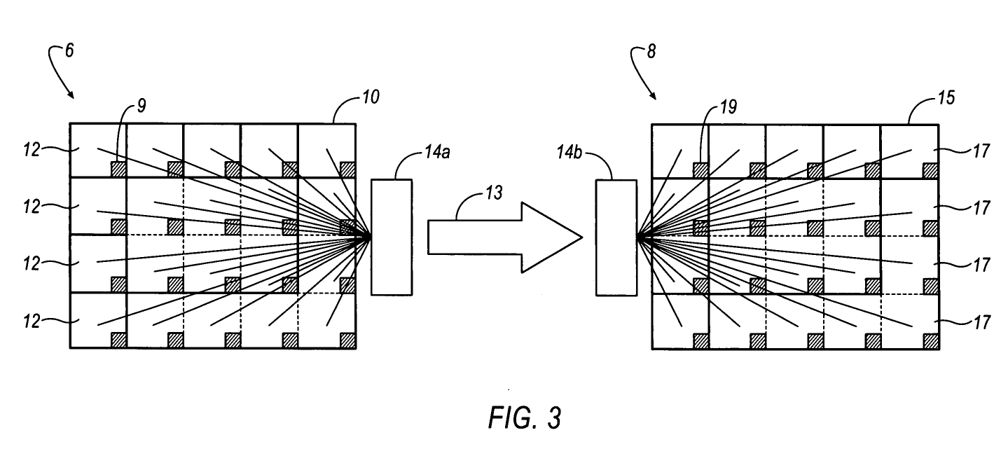

Referring now to FIG. 3, another embodiment of the invention is shown and described. As shown in FIG. 3, the encryption logic 9 is provided right at the pixel level. Specifically, each source pixel 12 includes a separate encryption logic 9 connected thereto. Likewise, each of the receiving pixels 17 includes decryption logic 19. The encryption logic 9 and decryption logic 19 can be embodied in a physical circuit located right in the pixel, a physical circuit connected directly to the pixel or can be virtually connected to each of the pixels through software programming in a video card or other similar device. As will be appreciated by one skilled in the art in light of this disclosure, the physical circuitry used to implement the encryption and decryption logic can be fabricated in the semi-conductor substrate having the microelectronics comprising the video capture or video display pixel array elements.

Each encryption logic 9 of each pixel 12 has a different encryption key from the remainder of the pixels 12. The digital picture information captured by each pixel 12 is encrypted by its respective encryption logic 9 and then is dispatched to pixel logic 14a. Pixel logic 14a then dispatches the captured digital picture information from pixels 12 across network 13 to receiving device 8. The pixel logic 14b addressably dispatches the received data stream of digital picture information to the respective encryption logic 19 in receiving pixels 17. The receiving pixels 17, like source pixels 12, include the encryption logic 19 in each respective receiving pixels 17 to decrypt the transmitted information. Each decryption logic 9 of each of the receiving pixels 17 contains the required decryption key to decrypt the digital picture information for that specific receiving pixel 17. As can be seen, if desired, each receiving logic 19 may need a separate decryption key, which makes decryption by an unauthorized individual extremely difficult as the unauthorized individual must determine every one of the plurality of decryption keys to view the picture information. Alternatively, groups of the decryption logic 19 may be given the same decryption keys.

Encryption logic 9 and decryption logic 19 may use any known encryption or decryption technique such as symmetric key, asymmetric key or any other known encryption/decryption schemes and the present invention is not limited by that disclosed herein. In one aspect, a public key is generated by each decryption logic 19 for use by the encryption logic 9 for encrypting that digital picture information. The public-key is an encryption key that is made available to everyone in the public. The decryption logic 19 retains its own private decryption key for decrypting the received data stream from source 6. As will be readily known to one skilled in the art, a public key may be used to actually encrypt the information, but both the public and private keys are needed to decrypt the information. This allows any individual to encrypt the information, and only allows an individual holding the private key to decrypt the encrypted information.

For example, as shown in FIG. 2, encryption logic 9 receives separate encryption keys for each of the regions 100, 102 and 104. The encryption keys may be public keys. Likewise, the decryption logic 19 is provided with the decryption keys for decrypting the transmitted data stream of digital picture information for regions 100a, 102a and 104a. The keys for regions 100a, 102a and 104a may be private keys. Alternatively, the decryption keys may be provided by an external source or generated within the decryption logic 19.

Similar to the embodiment of FIG. 2, the embodiment of FIG. 3 may provide each encryption logic 9 in each respective source pixel 12 with a public encryption key. A private key may then be held by the decryption logic 19 for decrypting the data stream transmitted thereto. Alternatively, a matching encryption/decryption key set may be dispatched to encryption logic 9 and decryption logic 19. By allowing the decryption key to be held right at the decryption logic 19, it becomes difficult for an unauthorized individual to access the decrypted information as the authorized individual must tap into a location between the decryption logic 19 and the receiving pixel 17

While the present invention has been particularly shown and described with reference to the foregoing preferred and alternative embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

1. A digital picture capturing device comprising:
a plurality of pixel elements arranged in an array and adapted to capture picture information; and
at least one encryption logic adapted to encrypt picture information from at least a first portion of the pixel elements with a first encryption key and to encrypt picture information from at least a second portion of the pixel elements with a second encryption key.

2. The digital picture capturing device according to claim 1, wherein:
the first portion is a first single pixel element; and
the second portion is a second single pixel element;
wherein the encryption logic is adapted to encrypt each of the pixel elements with a different encryption key.

3. The digital picture capturing device according to claim 2, wherein:
the encryption logic is a plurality of encryption logics; and
each of the encryption logics connects to a respective one of the pixels.

4. The digital picture capturing device according to claim 3, wherein each of the plurality of encryption logics is located at a respective one of the pixels.

5. The digital picture capturing device according to claim 1, wherein the first portion is a first plurality of pixels and the second portion is a second plurality of pixels.

6. The digital picture capturing device according to claim 5, wherein the encryption logic is a single component that encrypts the first portion with the first encryption key and encrypts the second portion with the second encryption key.

7. The digital picture capturing device according to claim 6, further comprising:
pixel logic adapted to receive picture information from the first portion and the second portion and adapted to dispatch the picture information to the encryption logic.

8. The digital picture capturing device according to claim 1, wherein the array is a picture gathering device of a digital camera.

9. A digital picture display device comprising:
a plurality of pixel elements arranged in an array and adapted to display picture information; and
at least one decryption device adapted to decrypt picture information for at least a first portion of the pixel elements with a first decryption key and to decrypt picture information for at least a second portion of the pixel elements with a second decryption key.

10. The digital picture display device according to claim 9, wherein:
the first portion is a first single pixel element; and
the second portion is a second single pixel element;
wherein the decryption device is adapted to decrypt picture information for each of the pixel elements with a different decryption key.

11. The digital picture display device according to claim 10, wherein:
the decryption device is a plurality of decryption devices;
each of the decryption devices connects to a respective one of the pixels.

12. The digital picture display device according to claim 11, wherein each of the decryption devices is positioned at a respective one of the pixels.

13. The digital picture display device according to claim 9, wherein the first portion is a first plurality of pixels and the second portion is a second plurality of pixels.

14. The digital picture display device according to claim 13, wherein the decryption device is a single component that decrypts the first portion with the first decryption key and decrypts the second portion with the second decryption key.

15. The digital picture display device according to claim 14, further comprising:
pixel logic adapted to receive decrypted picture information for the first portion from the decryption device and to receive decrypted picture information for the second portion from the decryption device and to dispatch the picture information for the first portion of pixel elements to the decryption device and to dispatch the picture information for the second portion to the second portion of pixel elements to the decryption device.

16. The digital picture display device according to claim 9, wherein the array is a picture gathering device of a digital camera.

17. A method for encrypting information from an array, comprising:
providing a plurality of pixels arranged in an array and adapted to capture picture information;
partitioning the plurality of pixels into a plurality of portions;
encrypting each of the plurality of portions with a respective one of a plurality of encryption keys, wherein each of the plurality of encryption keys is different than a remainder of the plurality of encryption keys.

18. The method according to claim 17, wherein each of the plurality of portions includes a plurality of pixels.

19. The method according to claim 17, wherein each of the plurality of portions includes only one pixel.

20. A method for receiving encrypted picture information, comprising:
providing a display device having a plurality of pixels organized into an array and adapted to display picture information;
receiving a data stream of digital picture information;
decrypting the data stream of digital picture information with a plurality of the encryption keys to obtain a plurality of portions of picture information for each respective one of the plurality of encryption keys; and
dispatching each of the plurality of portions to respective ones of a plurality of different pixel groups in the array.

21. The method according to claim 20, wherein each of the different pixel groups comprises a plurality of pixels

22. The method according to claim 20, wherein each of the plurality of pixel groups includes only one pixel.

23. A micro electronic device, comprising:
an array of display pixels collectively configured to display visible images; and
a plurality of decryption logic components, each decryption logic component associated with different group of the display pixels and configured to decrypt video data directed to the respective group of display pixels.

24. The micro electronic device of claim 23, wherein each group of display pixels comprises a single display pixel.

25. A display device, comprising:
a means for displaying visible images from digital data, wherein said display means is segmentable into a plurality of portions; and
a decryption means for decrypting encrypted digital data directed to said portions using a plurality of decryption keys, wherein each portion is associated with a different decryption key.
